(19) United States
(12) Patent Application Publication
(10) Pub. No.: US 2020/0177263 A1
(43) Pub. Date: Jun. 4, 2020

(54) Method and Apparatus for Transmitting Beam Failure Recovery Request

(71) Applicant: MediaTek Singapore Pte. Ltd., Singapore (SG)

(72) Inventor: Yuanyuan Zhang, Beijing (CN)

(21) Appl. No.: 16/784,397

(22) Filed: Feb. 7, 2020

Related U.S. Application Data
(63) Continuation of application No. PCT/CN2018/099857, filed on Aug. 10, 2018.

(30) Foreign Application Priority Data
Aug. 10, 2017 (CN) PCT/CN2017/096815

(51) Int. Cl. H04B 7/06; H04W 16/28; H04W 76/27; H04W 72/10; H04W 74/08; H04W 74/02

(52) U.S. Cl. CPC H04B 7/0695; H04W 16/28; H04W 74/02; H04W 72/10; H04W 74/0833; H04W 76/27

(57) ABSTRACT

Apparatus and methods are provided for beam failure recovery request (BFRR) transmission. In one novel aspect, one or more beam failure (BF) instances are detected in a communication network. The communication network has multiple cells each configured with multiple beams. A BFRR is repeated transmitted with a timer or counter controlled transmission on one or more beams of one or more selected type of physical channels until a BFRR response is received from the communication network or a control stop is reached. The selected type of physical channel is selected based on a channel priority rule. The UE indicates a BFRR failure to a radio resource control (RRC) layer when the control stop is reached without receiving the BFRR response. In one embodiment, upon determining a control stop is reached, the UE selects a new physical channel based on the channel priority rule and re-transmits the BFRR on the newly selected physical channel.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2018/099857, with an international filing date of Aug. 10, 2018, which in turn claims priority from International Application No. PCT/CN2017/096815 filed on Aug. 10, 2017. This application is a continuation of International Application No. PCT/CN2018/099857, which claims priority from International Application No. PCT/CN2017/096815. International Application No. PCT/CN2018/099857 is pending as of the filing date of this application, and the United States is a designated state in International Application No. PCT/CN2018/099857. The disclosure of each of the foregoing documents is incorporated herein by reference.

### TECHNICAL FIELD

The disclosed embodiments relate generally to wireless communication, and, more particularly, to transmit beam failure recovery.

### BACKGROUND

The fifth generation (5G) radio access technology (RAT) will be a key component of the modern access network. It will address high traffic growth and increasing demand for high-bandwidth connectivity. It will also support massive numbers of connected devices and meet the real-time, high-reliability communication needs of mission-critical applications. Both the standalone new radio (NR) deployment and non-standalone NR with LTE/eLTE deployment will be considered. For example, the incredible growing demand for cellular data inspired the interest in high frequency (HF) communication system. One of the objectives is to support frequency ranges up to 100 GHz. The available spectrum of HF band is 200 times greater than conventional cellular system. The very small wavelengths of HF enable large number of miniaturized antennas to be placed in small area. The miniaturized antenna system can form very high gain, electrically steerable arrays and generate high directional transmissions through beamforming.

Beamforming is a key enabling technology to compensate the propagation loss through high antenna gain. The reliance on high directional transmissions and its vulnerability to the propagation environment introduces particular challenges including intermittent connectivity and rapidly adaptable communication. HF communication will depend extensively on adaptive beamforming at a scale that far exceeds current cellular system. High reliance on directional transmission such as for synchronization and broadcast signals may delay the base station detection during cell search for initial connection setup and handover since both the base station and the mobile stations need to scan over a range of angles before a base station can be detected.

Improvements and enhancements are required for beam failure recovery procedure in the NR network.

### SUMMARY

Apparatus and methods are provided for BFRR transmission. In one novel aspect, one or more beam failure (BF) instances are detected in a communication network. The communication network has multiple cells each configured with multiple beams. A BFRR is repeated transmitted with a timer or counter controlled transmission on one or more beams of one or more selected type of physical channels until a BFRR response is received from the communication network or a control stop is reached. The selected type of physical channel is selected based on a channel priority rule. The UE indicates a BFRR failure to a radio resource control (RRC) layer when the control stop is reached without receiving the BFRR response. In one embodiment, upon determining a control stop is reached, the UE selects a new physical channel based on the channel priority rule and re-transmits the BFRR on the newly selected physical channel.

In one embodiment, the one or more BFRR indications are generated by the PHY layer of the UE. In another embodiment, the one or more BFRR indications are generated by a MAC layer of the UE if a beam failure occurs when one or more candidate beams are available. In another embodiment, a candidate-beam timer is started upon detecting a beam failure, and the UE stops the candidate-beam timer when one or more candidate beams are available, otherwise, indicates to the RRC layer of no candidate beam being available upon the candidate-beam timer expiration.

In one embodiment, the channel priority rule is to select a highest priority physical channel that is available based on a UL physical channel type in a descending order of a PUCCH, a non-contention NR PRACH, and a contention NR-PRACH. The physical channel is available if there is at least one candidate beam associated with it and no previous control stop was reached on the physical channel. In one embodiment, each physical channel type is configured with corresponding timer that is started at a beginning of the BFRR transmission on corresponding physical channel, or corresponding transmission counter that is increased by one for each BFRR transmission on corresponding physical channel, or both corresponding timer and transmission counter. In another embodiment, a BFRR timer, or a BFRR transmission counter, or a BFRR timer and a BFRR transmission counter is configured for BFRR transmissions on all configured available physical channels, and wherein the BFRR timer is started at a beginning of the BFRR transmission and the BFRR transmission counter is increased by one for each BFRR transmission. In yet another embodiment, a PUCCH timer and/or a PUCCH counter is configured for the BFRR transmission on the PUCCH; and a RA timer and/or a RA counter is configured for the entire process of the non-contention based BFRR transmission and the contention based BFRR transmission.

In one embodiment, when a plurality of candidate beams are available on a physical channel, the UE selects a different candidate beam for each retransmission of the BFRR. In another embodiment, the UE suspends all UL transmissions except the BFRR transmission.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network 100 with controlled BFRR transmission in accordance with embodiments of the current invention.

FIG. 2A illustrates an exemplary NR wireless system with multiple control beams and dedicated beams in multiple directionally configured cells in accordance with embodiments of the current invention.

FIG. 2B illustrates an exemplary control beam configuration for UL and DL of the UE in accordance with embodiments of the current invention.

FIG. 3 illustrates exemplary diagrams of functional modules for the controlled transmission of BFRR in accordance with embodiments of the current invention.

FIG. 4 illustrates an exemplary flow chart of the BFRR trigger by the PHY layer in accordance with embodiments of the current invention.

FIG. 5A illustrates an exemplary flow chart of the BFRR trigger by the MAC layer in accordance with embodiments of the current invention.

FIG. 5B illustrates an exemplary flow chart of the BFRR trigger by the MAC layer with a control timer in accordance with embodiments of the current invention.

FIG. 5C illustrates an exemplary flow chart of the BFRR trigger by the MAC layer with a control timer and a serving beam self-recovery in accordance with embodiments of the current invention.

FIG. 6 illustrates exemplary tables for candidate beam storage in accordance with embodiments of the current invention.

FIG. 7A illustrates an exemplary flowchart for BFRR transmission through PUCCH controlled by a counter in accordance with embodiments of the current invention.

FIG. 7B illustrates an exemplary flowchart for BFRR transmission through PUCCH controlled by a timer in accordance with embodiments of the current invention.

FIG. 8A illustrates an exemplary flowchart for BFRR transmission through non-contention PRACH controlled by a counter in accordance with embodiments of the current invention.

FIG. 8B illustrates an exemplary flowchart for BFRR transmission through non-contention PRACH controlled by a timer in accordance with embodiments of the current invention.

FIG. 9A illustrates an exemplary flowchart for BFRR transmission through contention PRACH controlled by a counter in accordance with embodiments of the current invention.

FIG. 9B illustrates an exemplary flowchart for BFRR transmission through contention PRACH controlled by a timer in accordance with embodiments of the current invention.

FIG. 10 illustrates an exemplary flowchart for BFRR transmission controlled by one or multiple timers and counter5 in accordance with embodiments of the current invention.

FIG. 11 illustrates an exemplary flowchart for BFRR transmission in accordance with embodiments of the current invention.

### DETAILED DESCRIPTION

Reference will now be made in detail to some embodiments of the invention, examples of which are illustrated in the accompanying drawings.

In the NR network with multiple beam operation, beam management is an important procedure to support beam-level mobility, which can be carried out as a set of PHY/MAC procedures to acquire and maintain a set of transmission reception points (TRPs) and/or UE beams used for downlink (DL) and uplink (UL) transmission/reception. In normal beam measurement procedure, both network and UE can reach each other without interruption. HF signals are extremely susceptible to shadowing due to the appearance of obstacles such as human body and outdoor materials. Therefore, signal blockage due to shadowing is a larger bottleneck in delivering uniform capacity. When the beam used for communication is blocked, certain mechanism is required to overcome a sudden beam quality drop and guarantee UE experienced data rate. Beam failure recovery procedure is as a complementary procedure of beam management. It is intended to handle the abnormal case such as sudden channel degradation due to blockage or beam misalignment due to fast channel variation. When beam failure recovery procedure is triggered, beam failure recovery request (BFRR) will be transmitted to the network. In one novel aspect, in connection with the transmission of BFRR, a controlled transmission is used to control the transmission and retransmission of the BFRR. In one embodiment, a control timer is used. In another embodiment, a transmission counter is used. When a control stop is reached, either the control timer expired or the transmission counter is greater than a maximum value, a new physical channel is selected for retransmission. In yet another embodiment, a BFRR indication is sent to the radio resource control (RRC) layer.

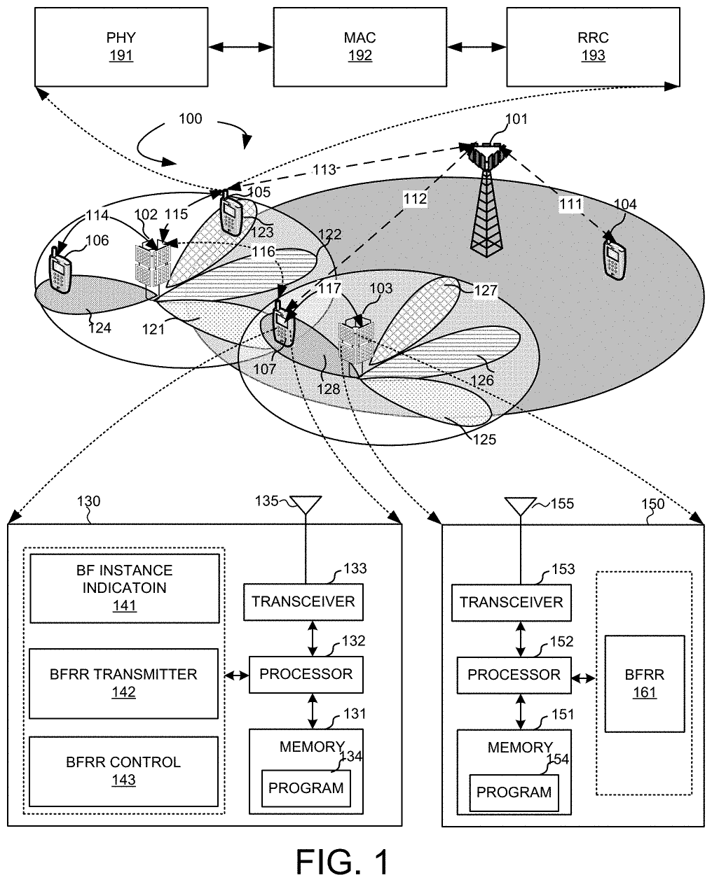

FIG. 1 is a schematic system diagram illustrating an exemplary NR wireless network 100 with controlled BFRR transmission in accordance with embodiments of the current invention. Wireless system 100 includes one or more fixed base infrastructure units forming a network distributed over a geographical region. The base unit may also be referred to as an access point, an access terminal, a base station, a Node-B, an eNode-B, a gNB, or by other terminology used in the art. As an example, base stations 101, 102 and 103 serve a number of mobile stations 104, 105, 106 and 107 within a serving area, for example, a cell, or within a cell sector. In some systems, one or more base stations are coupled to a controller forming an access network that is coupled to one or more core networks. eNB/gNB 101 is a conventional base station served as a macro eNB/gNB. gNB 102 and gNB 103 are NR base stations, the serving area of which may overlap with serving area of eNB/gNB 101, as well as may overlap with each other at the edge. NR gNB 102 and gNB 103 has multiple sectors each with multiple beams to cover a directional area respectively. Beams 121, 122, 123 and 124 are exemplary beams of gNB 102. Beams 125, 126, 127 and 128 are exemplary beams of gNB 103. The coverage of gNB 102 and 103 can be scalable based on the number of TRPs radiating the different beams. As an example, UE or mobile station 104 is only in the service area of gNB 101 and connected with gNB 101 via a link 111. UE 106 is connected with HF network only, which is covered by beam 124 of gNB 102 and is connected with gNB 102 via a link 114. UE 105 is in the overlapping service area of gNB 101 and gNB 102. In one embodiment, UE 105 is configured with dual connectivity and can be connected with eNB/gNB 101 via a link 113 and gNB 102 via a link 115 simultaneously. UE 107 is in the service areas of eNB/gNB 101, gNB 102, and gNB 103. In an embodiment, UE 107 is configured with dual connectivity and can be connected with eNB/gNB 101 with a link 112 and gNB 103 with a link 117. In an embodiment, UE 107 can switch to a link 116 connecting to gNB 102 upon connection failure with gNB 103.

FIG. 1 further illustrates simplified block diagrams 130 and 150 for UE 107 and gNB 103, respectively. Mobile station 107 has an antenna 135, which transmits and receives radio signals. A RF transceiver module 133, coupled with the antenna, receives RF signals from antenna 135, converts them to baseband signal, and sends them to processor 132. RF transceiver module 133 is an example, and in one embodiment, the RF transceiver module comprises two RF modules (not shown), first RF module is used for mmW transmitting and receiving, and another RF module is used for different frequency bands transmitting and receiving which is different from the mmW transceiving. RF transceiver 133 also converts received baseband signals from processor 132, converts them to RF signals, and sends out to antenna 135. Processor 132 processes the received baseband signals and invokes different functional modules to perform features in mobile station 107. Memory 131 stores program instructions and data 134 to control the operations of mobile station 107.

Mobile station 107 also includes multiple function modules that carry out different tasks in accordance with embodiments of the current invention. BF instance indication circuit 141 creates one or more BF instances based on one or more detected BF conditions. A BFRR transmitter 142 transmits a BFRR repeatedly on one or more candidate beams of one or more selected physical channels until a BFRR response is received from the NR network or a control stop is reached, wherein the selected physical channel is selected based on a channel priority rule, and wherein the control stop is reached when detecting at least one stop conditions comprising a timer expired and a transmission counter reached a predefine maximum value. A BFRR controlling circuit 143 considers the BFRR procedure succeed and cancels all pending BFRRs if the BFRR response is received from the NR network, otherwise indicates a BFRR failure to a RRC layer when the control stop is reached without receiving the BFRR response.

Similarly, gNB 103 has an antenna 155, which transmits and receives radio signals. A RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in eNB 103. Memory 151 stores program instructions and data 154 to control the operations of gNB 103. gNB 103 also includes multiple function modules that carry out different tasks in accordance with embodiments of the current invention. A BFRR circuit 161 handles BFRR procedures of the gNB 103.

FIG. 1 further shows different protocol layers and the interaction between different layers that handle beam management and beam failure recovery in the NR system with multiple beam operation. UE 105 has a physical layer 191, which performs measurement and transmits/receives physical signals. In one embodiment, it indicates to MAC that BFRR should be triggered together with the list of candidate beams and the associated UL physical channels for each candidate beam. In another embodiment, it indicates the measurement results of both serving beam and candidate beam to MAC layer. MAC layer 192 performs BFRR triggering, BFRR transmission, BFRR cancellation and interaction with UL transmission. RRC layer 193 controls RRC connection with the network.

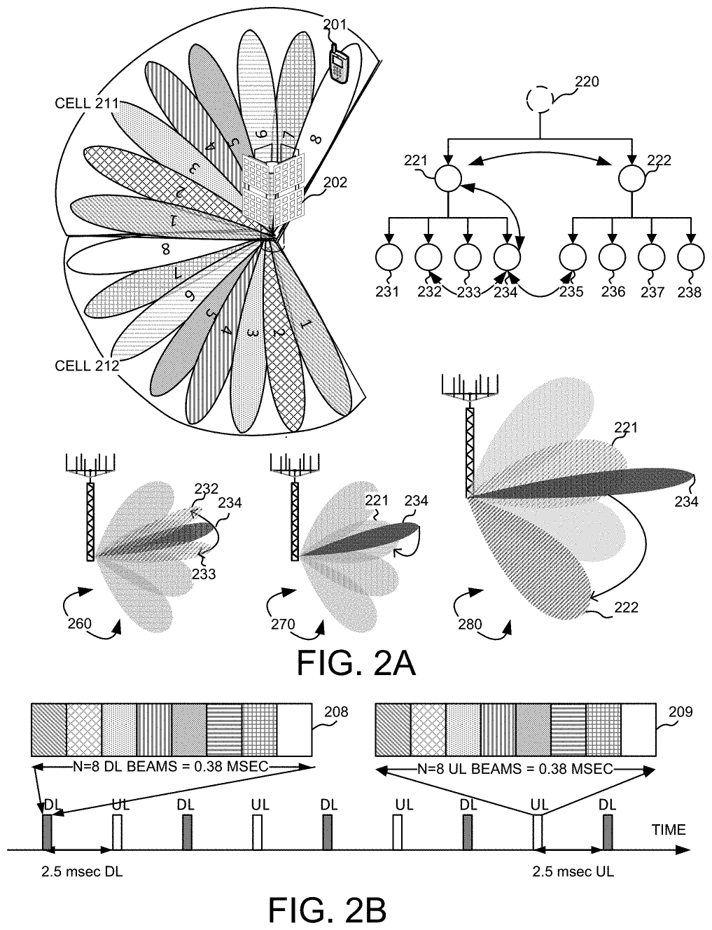

FIG. 2A illustrates an exemplary NR/HF wireless system with multiple control beams and dedicated beams in multiple directionally configured cells. A UE 201 is connected with a gNB 202. gNB 202 is directionally configured with multiple sectors/cells. Each sector/cell is covered by a set of coarse TX control beams, which are broadcast. As an example, cells 221 and 222 are configured cells for gNB 202. In one example, three sectors/cells are configured, each covering a 120° sector. In one embodiment, each cell is covered by eight control beams. Different control beams are time division multiplexed (TDM) and distinguishable. Phased array antenna is used to provide a moderate beamforming gain. The set of control beams is broadcast repeatedly and periodically. Each control beam broadcasts the cell-specific information such as synchronization signal, system information, and beam-specific information. Besides coarse TX control beams, there are multiple dedicated beams, which are finer-resolution BS beams.

Beam tracking is an important function for the NR mobile stations. Multiple beams, including coarse control beams and dedicated beams are configured for each of the directionally configured cells. The UE monitors the qualities of its neighboring beams by beam tracking. FIG. 2A illustrates exemplary beam tracking/switching scenarios. A cell 220 has two control beams 221 and 222. Dedicated beams 231, 232, 233 and 234 are associated with control beam 221. Dedicated beams 235, 236, 237 and 238 are associated with control beam 222. In one embodiment, the UE connected via dedicated beam 234, monitors its neighboring beams for control beam 221. Upon a beam-switching decision, the UE can switch from beam 234 to beam 232 and vice versa. In another embodiment, the UE can fall back to control beam 221 from dedicated beam 234. In yet another embodiment, the UE also monitors dedicated beam 235 configured for control beam 222. The UE can switch to dedicated beam 235, which belongs to another control beam.

FIG. 2A also illustrates three exemplary beam-switching scenarios 260, 270 and 280. UE 201 monitors neighboring beams. The sweeping frequency depends on the UE mobility. The UE detects dropping quality of the current beam when the current beam quality degrades by comparing with coarse resolution beam quality. The degradation may be caused by tracking failure, or the channel provided by refined beam is merely comparable to the multipath-richer channel provided by the coarse beam. Scenario 260 illustrates the UE connected with 234 monitors its neighboring dedicated beams 232 and 233 configured for its control beam, i.e. control beam 221. The UE can switch to beam 232 or 233. Scenario 270 illustrates the UE connected with 234 can fall back to the control beam 221. Scenario 280 illustrates the UE connected with 234 associated with control beam 221 can switch to another control beam 222.

FIG. 2B illustrates an exemplary control beam configuration for UL and DL of the UE in accordance with the current invention. A control beam is a combination of downlink and uplink resources. The linking between the beam of the DL resource and the beam of the UL resources is indicated explicitly in the system information or beam-specific information. It can also be derived implicitly based on some rules, such as the interval between DL and UL transmission opportunities. In one embodiment, A DL frame 208 has eight DL beams occupying a total of 0.38 msec. A UL frame 209 has eight UL beams occupying a total of 0.38 msec. The interval between the UL frame and the DL frame is 2.5 msec.

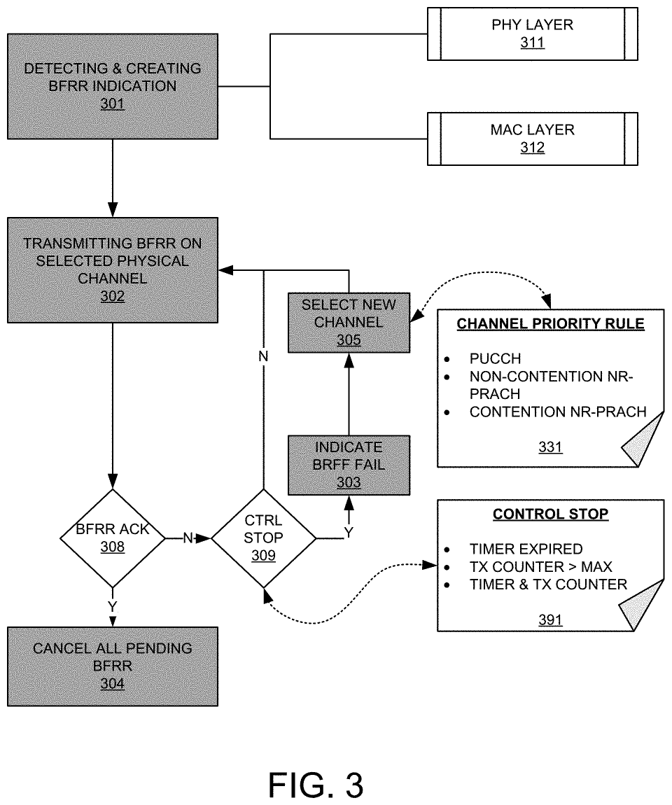

FIG. 3 illustrates exemplary diagrams of functional modules for the controlled transmission of BFRR in accordance with embodiments of the current invention. In one novel aspect, the BFRR is triggered by either the MAC layer or the PHY layer. At step 301, a BFRR indication is detected and/or created to trigger the controlled transmission of the BFRR. The BFRR procedure can be triggered when one or more beam failure (BF) instances are detected. In one embodiment, as in 311, the PHY layer triggers the BFRR procedure. In another embodiment, as in 312, the MAC layer monitors indications from the PHY layer and maintains a list of candidate beams, which is generated by PHY layer. The MAC layer upon determining a BFRR is required, trigger the controlled BFRR procedure. At step 302, once the BFRR is triggered, the UE transmits the BFRR on one or more beams of a selected physical channel. The BFRR transmission is controlled by either a timer, a transmission counter or a combination of a timer and a transmission counter. At step 308, the UE monitors a network BFRR response. If the BFRR is received, at step 304, the UE cancels all pending BFRR. If there is no BFRR response received, the UE check if a control stop reached at step 309. The control stop 391 is reached when the timer expired, or the transmission counter reached a preconfigured maximum number, or when both a timer and a transmission counter is used for the BFRR transmission, either one triggers the condition of the control stop being reached. If the control stop is not reached, the UE moves back to step 302 and retransmits the BFRR on the same type of UL physical channel. In one embodiment, when there are multiple candidate beams associated with the physical channel, a different candidate beam is selected for each retransmission. If at step 309, the UE determines that a control stop is reached, the UE moves to step 303 and indicates to the RRC layer of the BRFF failure.

Subsequently, at step 305, the UE selects a new type of UL physical channel and moves back to step 302 and retransmits the BFRR on the newly selected type of UL physical channel. The selection of the physical channel follows a physical channel priority rule 331. The channel priority rule instructs to select the channel in the descending order of a physical uplink common channel (PUCCH), a non-contention NR physical random-access channel (PRACH), and a contention NR-PRACH.

In one novel aspect, the BFRR procedure is triggered when one or more conditions are detected. In one embodiment, the BFRR procedure is triggered by the PHY layer. In another embodiment, the BFRR procedure is triggered by the MAC layer.

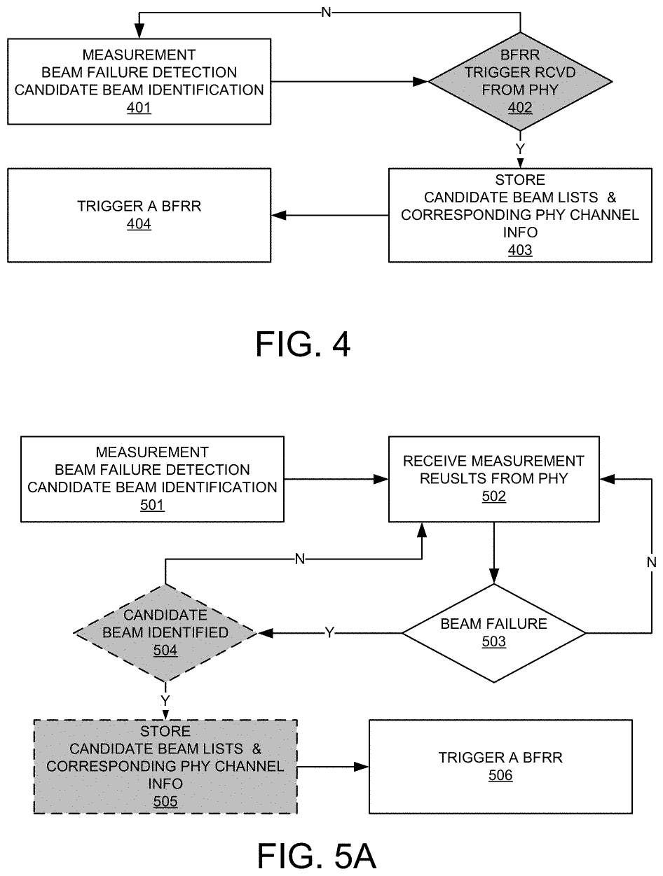

FIG. 4 illustrates an exemplary flow chart of the BFRR trigger by the PHY layer in accordance with embodiments of the current invention. At step 401, the PHY performs measurement, beam fail detection, candidate beam identification and indicates BFRR trigger to the MAC. At step 402, the MAC determines whether the BFRR triggered is received. If step 402 determines no, the UE moves back to step 401 and continues the PHY monitoring. When PHY sends the BFRR trigger indication to MAC (i.e., yes in step 402), it also sends the candidate beam lists and the corresponding PHY channel information. If step 402 determines yes, the MAC receives an indication for BFRR trigger, it stores the candidate beam lists as well as the corresponding PHY channel information at step 403. At step 404, the BFRR procedure is triggered.

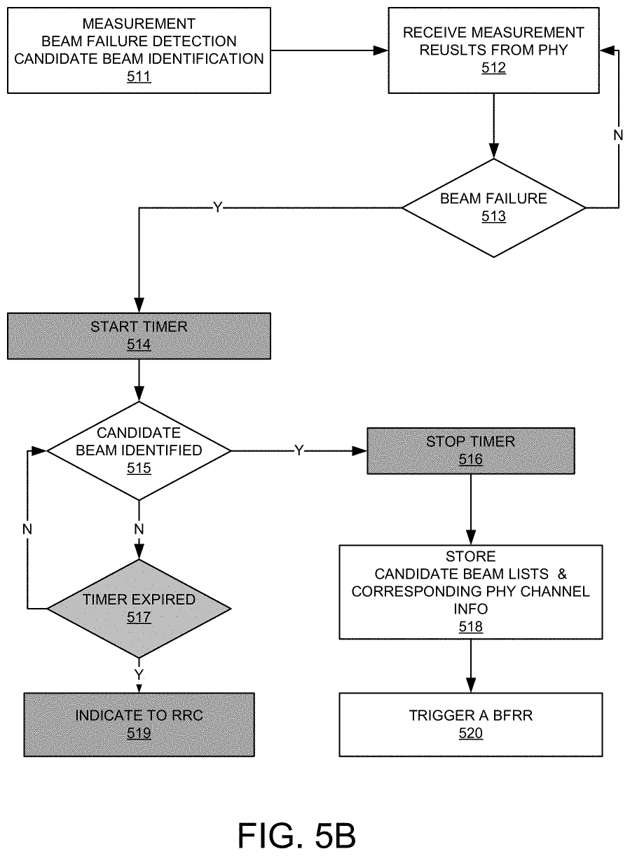

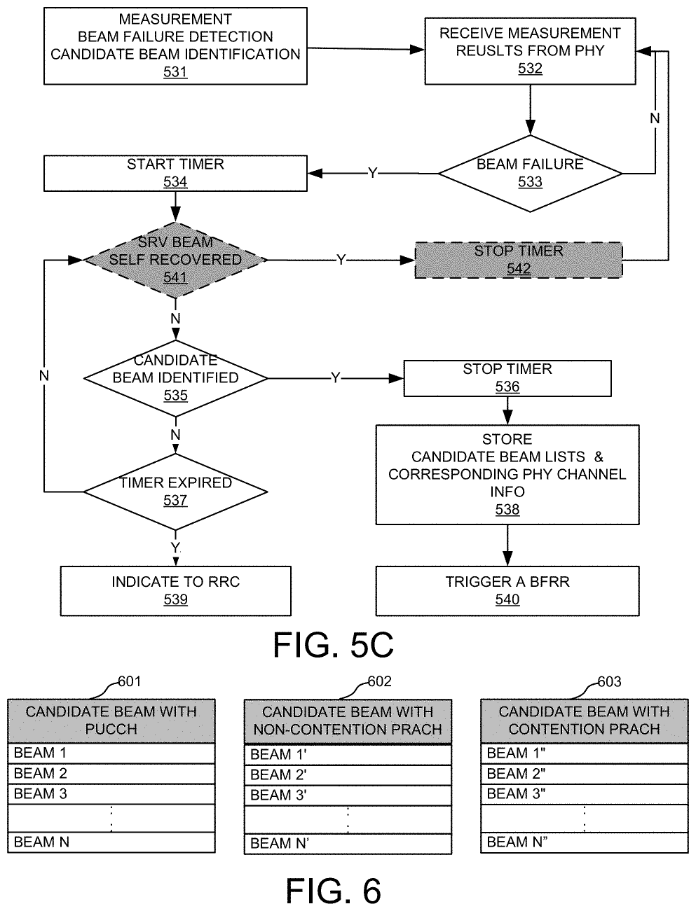

FIG. 5A illustrates an exemplary flow chart of the BFRR trigger by the MAC layer in accordance with embodiments of the current invention. At step 501, the PHY performs measurement, beam fail detection and candidate beam identification. At step 502, the MAC receives the measurement results of both the serving beam and candidate beams. At step 503, the MAC layer checks whether the beam failure occurs based on one or more problem detection conditions. In one embodiment, the beam failure is detected if the link quality of the serving beam is below a threshold to maintain the connectivity for a predefined or preconfigured evaluation period. In another embodiment, the beam failure is detected when one or more problem detection events occur for a predefined number of consecutive times. In yet another embodiment, the beam failure is detected when one or more problem detection events occur and endure for a predefined or preconfigured duration. For example, a problem detection event is one generated Qout reusing current radio link monitoring procedure based on the measurement on the serving beam. The evaluation period to generate Qout can be configured. In another example, the problem detection event is the measurement result of Ll-RSRP or the CSI being below a threshold, which is configured by the network. In one embodiment, at step 504, the MAC layer checks whether there is at least one candidate beam available and stores the candidate beam list together with their corresponding physical channel information at step 505. At step 506, the BFRR procedure is triggered.

FIG. 5B illustrates an exemplary flow chart of the BFRR trigger by the MAC layer with a control timer in accordance with embodiments of the current invention. The PHY performs measurement, beam fail detection and candidate beam identification at step 511. At step 512, the MAC receives the measurement results of both serving beam and candidate beams. At step 513, MAC layer checks whether beam failure occurs based on one or more problem detection conditions. If the beam failure occurs, a timer T0, the candidate-beam timer, is started at step 514. Then MAC layer checks whether there is at least one candidate beam available at step 515. If there is candidate beam available, T0 is stopped at step 516. Then MAC layer stores the candidate beam list together with the corresponding physical channel information at step 518. Then BFRR procedure is triggered at 520. If there are no candidate beams available, the MAC layer continues to receive the measurement results from PHY until T0 expires or at least one candidate beam is available, whichever comes first. If T0 expires, at step 517, the MAC considers there is no candidate beam available and indicates beam recovery failure to the RRC at step 519.

FIG. 5C illustrates an exemplary flow chart of the BFRR trigger by the MAC layer with a control timer and a serving beam self-recovery in accordance with embodiments of the current invention. PHY performs measurement, beam fail detection and candidate beam identification at step 531. At step 532, MAC receives the measurement results of both serving beam and candidate beams. At step 533, MAC layer checks whether beam failure occurs based on one or more problem detection conditions. If beam failure occurs, a timer T0, the candidate-beam timer, is started at step 534. Then MAC layer checks whether there is at least one candidate beam available at step 535. If there are one or more candidate beams available, T0 is stopped at step 536. Then MAC layer stores the candidate beam list together with the corresponding physical channel information at step 538. Then BFRR procedure is triggered at step 540. If there is no candidate beams available, MAC layer continues to receive the measurement results from physical layer until T0 expires or at least one candidate beam is available, whichever comes first. If T0 expires at step 537, MAC considers there is no candidate beam available and indicates beam recovery failure to RRC at step 539. In one embodiment, a self-recovery procedure is supported after beam failure detection in case the serving beams becomes better. If the serving beam is self-recovered at step 541, T0 is stopped at step 542 and MAC layer continues to receive measurement results from physical layer. Otherwise, MAC layer checks whether there is candidate beam available at step 535.

In one embodiment, the beam failure is considered as self-recovered when one or more predefined recovery events occur for a predefined number of consecutive times. In another embodiment, the beam failure is considered as self-recovered when one or more recovery events occur and endure for a predefined or preconfigured duration. For example, a recovery event is one generated Qin reusing current radio link monitoring procedure based on the measurement on the serving beam. The evaluation period to generate Qin can be configured. In another embodiment, a recovery event is the measurement result of Ll-RSRP or CSI being above a predefined or preconfigured threshold. The threshold can be configured by the NR network.

The UE maintains a list of candidate beams when they are available. In one embodiment, the list of candidate beams is grouped by the physical channel it associated with. The candidate beam list can be maintained by the MAC layer.

FIG. 6 illustrates exemplary tables for candidate beam storage in accordance with embodiments of the current invention. Table 601 shows the candidate beams with PUCCH configured. Table 602 shows the candidate beams with non-contention PRACH. One candidate beam can be associated to both PUCCH and non-contention PRACH. Table 603 shows the candidate beams associated with neither PUCCH nor non-contention PRACH. The candidate beams are gNB Tx beams, which is associated to either CSI-RS or NR-SS.

Upon detecting the BFRR trigger and obtaining one or more valid candidate beams, the UE transmits the BFRR to the NR network using a controlled transmission on selected physical channel. The control transmission is controlled by either a timer, a transmission counter or a combination of a timer and a transmission counter. The physical channel is selected based on a channel priority rule. The channel priority rule is to select a highest priority physical channel that is available based on a physical channel type. In one embodiment, the physical channel has different priorities in a descending order of the PUCCH, the non-contention PRACH, and a contention PRACH. The physical channel is available if there is at least one candidate beam associated with it and no previous control stop was reached on the physical channel.

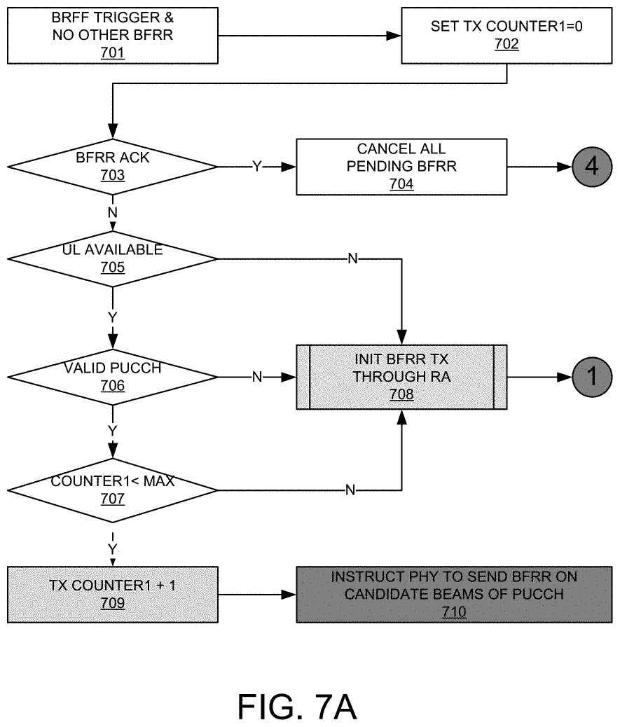

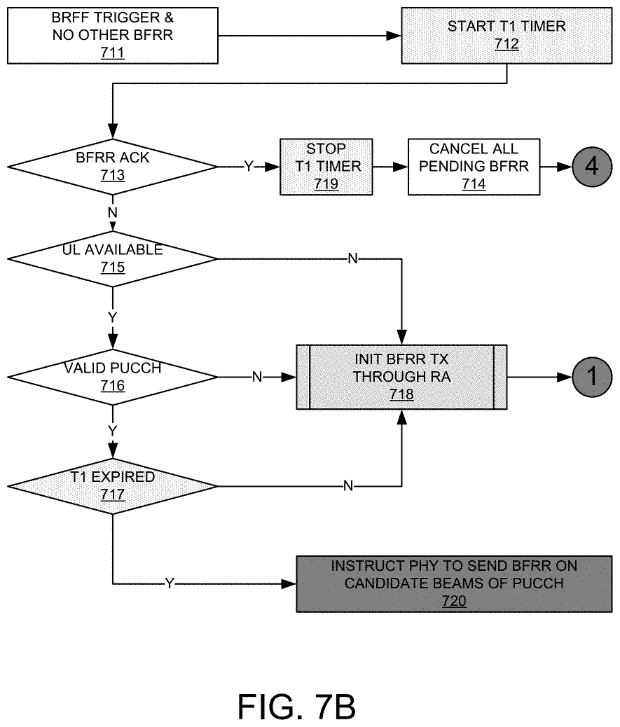

FIG. 7A illustrates an exemplary flowchart for BFRR transmission through PUCCH controlled by a counter in accordance with embodiments of the current invention. At step 701, a BFRR is triggered and there is no other BFRR pending. At step 702, a transmission counter, Counter1 is initialized and set to zero. If a response for a BFRR is received at step 703, all pending BFRRs are cancelled at step 704. The BFRR procedure succeeds and UE goes to point (4) and ends the BFRR procedure. Otherwise, the MAC checks whether UL is still available without beam failure at step 705. If UL is still available, MAC checks whether there is valid PUCCH for the candidate beams at step 706. If there is no valid UL or no valid PUCCH available, the MAC initiates contention or non-contention based RA procedure for the BFRR transmission at step 708. At step 706 if the UE has valid PUCCH for candidate beams, the UE checks whether Counter1 is less than a predefined or preconfigured maximum value, Maximum1, at step 707. If step 707 determines yes, the MAC increments Counter1 by one at step 709 and instructs the PHY layer to send BFRR on the valid PUCCH associated to the candidate beams at step 710. If Counter1 reaches Maximum1 as determined at step 707, the MAC initiates non-contention based RA procedure for BFRR transmission at step 708 when the non-contention PRACH resources for BFRR are configured. Otherwise, contention-based PRACH is initiated at step 708. The UE goes to point (1) of the RA procedure to transmit the BFRR. Table-7A illustrates an example of controlled BFRR transmission on the PUCCH.

TABLE 7A
The BFRR is used for requesting a new gNB Tx beam for DL
transmission when beam failure occurs.
When a BFRR is triggered, it shall be considered as
pending until it is cancelled.
All pending BFRR(s) shall be cancelled if a response from
the network for a BFRR is received.
If a BFRR is triggered and there is no other BFRR
pending, the MAC entity shall set the BFRR_COUNTER to
zero.
As long as one BFRR is pending, the MAC entity shall for
each TTI:
if no response for BFRR is received in this TTI:

| | |
|---|---|
| • | if the MAC entity has no valid PUCCH resource for |

BFRR configured in any TTI && non-contention based
PRACH resources are configured for BFRR;

| | |
|---|---|
| ∘ | initiate a non-contentaion based Random Access |

procedure;

| • | else initiate a contentaion based Random Access |
|---|---|
| | procedure; |
| • | else if the MAC entity has at least one valid PUCCH |

resource for BFRR configured for this TTI:

| | |
|---|---|
| ∘ | if BFRR_COUNTER < BFRR-TransMax: |

| | |
|---|---|
| - | increment BFRR_COUNTER by 1; |
| - | instruct the physical layer to signal the |

BFRR on one valid PUCCH resource for SR;

| | |
|---|---|
| ∘ | else: |

| | |
|---|---|
| - | if non-contention based PRACH resources |

are configured for BFRR;

| | |
|---|---|
| • | initiate a non-contentaion based |

Random Access procedure;

| | |
|---|---|
| - | else initiate a contentaion based Random |

Access procedure.

FIG. 7B illustrates an exemplary flowchart for BFRR transmission through PUCCH controlled by a timer in accordance with embodiments of the current invention. At step 711, a BFRR is triggered and there is no other BFRR pending. At step 712, timer T1 is started. If a response for a BFRR is received at step 713, the UE stops timer T1 t step 719 and all pending BFRRs are cancelled at step 714. The BFRR procedure succeeds and the UE goes to point (4) as the end of the BFRR procedure. Otherwise, MAC checks whether UL is still available without beam failure at step 715. If UL is still available, MAC checks whether there is valid PUCCH for the candidate beams at step 716. If there is no UL available or there is no valid PUCCH available, the MAC initiates the non-contention based RA procedure for BFRR transmission at step 718. At step 716 if the UE has valid PUCCH for candidate beams, MAC checks whether timer T1 expires at step 717. If step 717 determines no, the MAC instructs the PHY to send BFRR on the valid PUCCH associated to the candidate beams at step 720. If T1 expires as determined by step 717, the MAC initiates non-contention based RA procedure for BFRR transmission if non-contention PRACH resources for BFRR are configured at step 718. Otherwise, contention-based PRACH may be initiated at step 718. Subsequently, the UE goes to point (1) for the RA procedure to transmit the BFRR. Table-7B illustrates an example of timer controlled BFRR transmission on the PUCCH.

TABLE 7B
The BFRR is used for requesting a new gNB Tx beam for DL
transmission when beam failure occurs.
When a BFRR is triggered, it shall be considered as
pending until it is cancelled.
If a BFRR is triggered and there is no other BFRR
pending, the MAC entity start the BFRR_TransTimer. If a
response for the BFRR is received, the MAC entity stop
the BFRR_TransTimer and all pending BFRR(s) shall be
cancelled.
As long as one BFRR is pending, the MAC entity shall for
each TTI:
if no response for BFRR is received in this TTI:

| | |
|---|---|
| • | if the MAC entity has no valid PUCCH resource for |

BFRR configured in any TTI && non-contention based
PRACH resources are configured for BFRR;

| | |
|---|---|
| ∘ | initiate a non-contentaion based Random Access |

procedure;

| | |
|---|---|
| • | else |

| | |
|---|---|
| ∘ | initiate a contentaion based Random Access |

procedure;

| | |
|---|---|
| • | else if the MAC entity has at least one valid PUCCH |

resource for BFRR configured for this TTI:

| | |
|---|---|
| ∘ | if BFRR_TransTimer doesn't expire: |

| | |
|---|---|
| - | instruct the physical layer to signal the |

BFRR on one valid PUCCH resource for SR;

| | |
|---|---|
| ∘ | else: |

| | |
|---|---|
| - | if non-contention based PRACH resources |

are configured for BFRR;

| | |
|---|---|
| • | initiate a non-contentaion based |

Random Access procedure;

| | |
|---|---|
| - | else |

| | |
|---|---|
| • | initiate a contentaion based Random |

Access procedure.

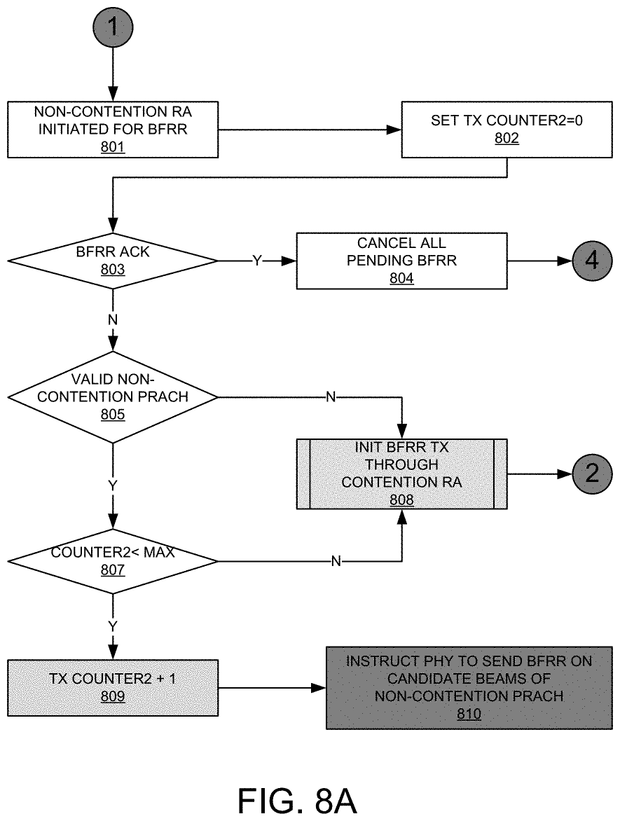

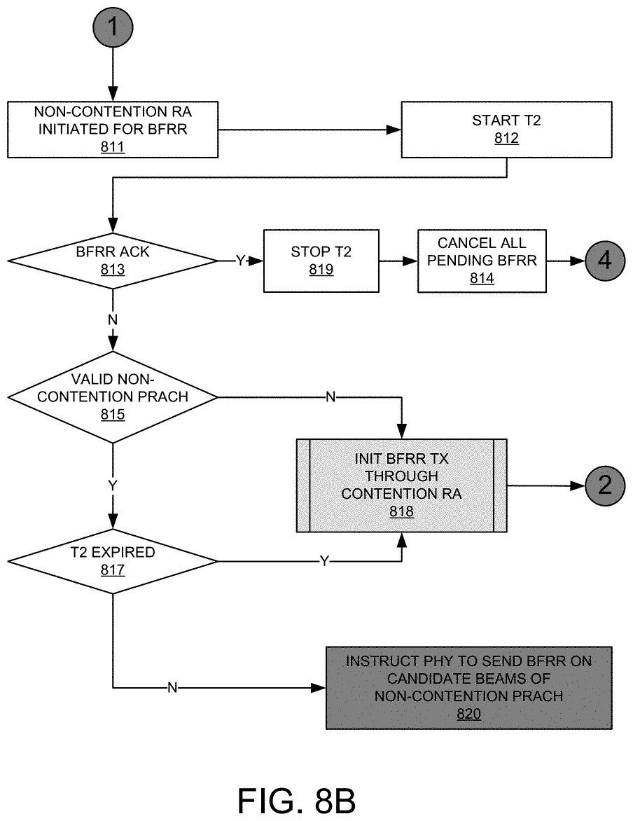

FIG. 8A illustrates an exemplary flowchart for BFRR transmission through non-contention PRACH controlled by a counter in accordance with embodiments of the current invention. At step 801 as the entrance of point (1), non-contention RA is initiated for BFRR transmission. At step 802, Counter2 is initialized and set to zero. If a response for a BFRR is received at step 803, all pending BFRRs are cancelled at step 804. The BFRR procedure succeeds and the UE goes to point (4) as the end of the BFRR procedure. Otherwise, the MAC checks whether there is valid non-contention PRACH for the candidate beams at step 805. If step 805 determines no, the MAC initiates contention based RA procedure for BFRR transmission at step 808. If step 805 determines yes that the UE has valid non-contention PRACH for candidate beams, the UE checks whether Counter2 is less than Maximum2 at step 807. If step 807 determines yes, the MAC increments Counter2 by one at step 809 and instructs the PHY to send BFRR on the valid non-contention PRACH associated to the candidate beams at step 810. If Counter2 reaches Maximum2 as determined at step 807, the MAC initiates contention based RA procedure for BFRR transmission. UE goes to point (2) for the contention based RA procedure.

FIG. 8B illustrates an exemplary flowchart for BFRR transmission through non-contention PRACH controlled by a timer in accordance with embodiments of the current invention. At step 811 as entrance of point (1), non-contention RA is initiated for BFRR transmission. At step 812, timer T2 is started. If a response for a BFRR is received at step 813, the UE stops timer T2 at step 819 and all pending BFRRs are cancelled at step 814. The BFRR procedure succeeds and the UE goes to point (4) as the end of the BFRR procedure. Otherwise, the MAC checks whether there is valid non-contention PRACH for the candidate beams at step 815. If step 815 determines no, the MAC initiates contention based RA procedure for BFRR transmission at step 818. At step 815 if the UE has valid non-contention PRACH for candidate beams, the MAC checks whether timer T2 expires at step 817. If step 817 determines no, the MAC instructs the PHY to send BFRR on the valid non-contention PRACH associated to the candidate beams at step 820. If T2 expires as determined at step 817, the MAC initiates contention based RA procedure for BFRR transmission at step 818. UE goes to point (2) for contention-based RA.

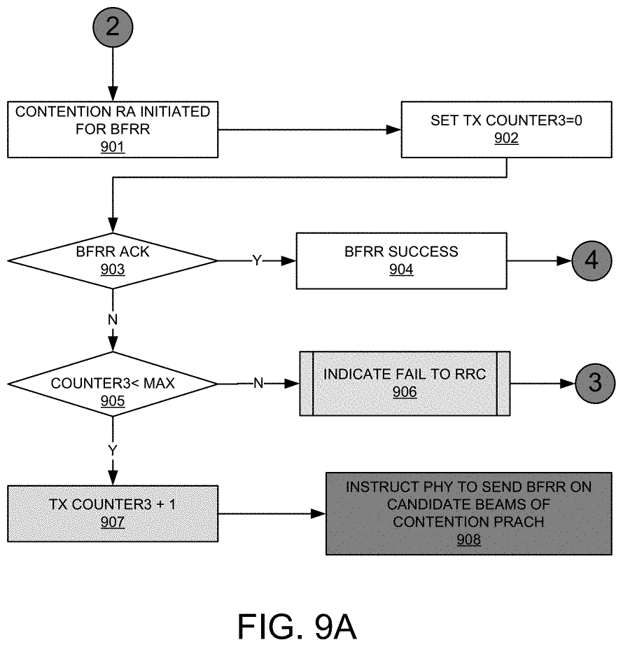

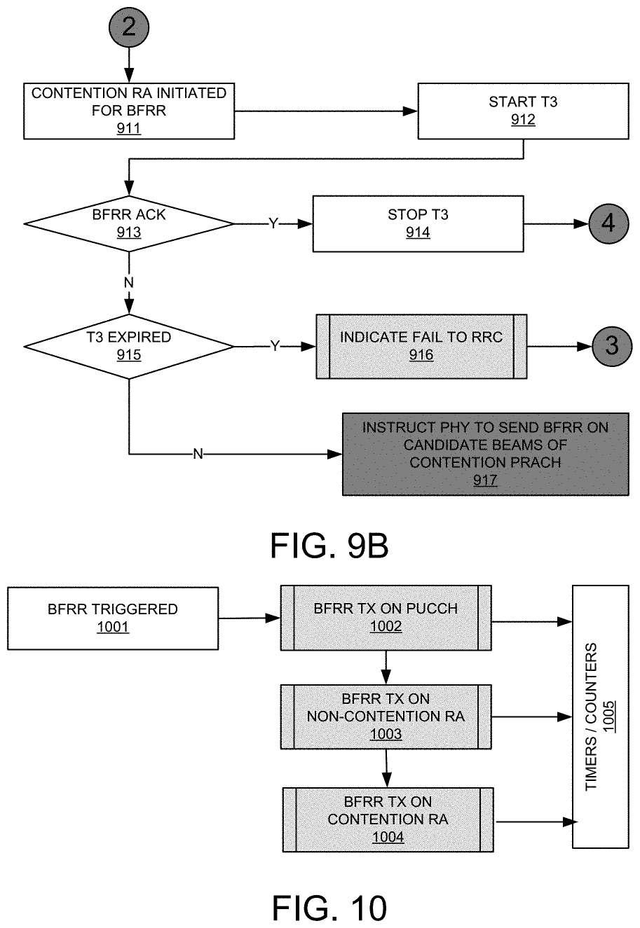

FIG. 9A illustrates an exemplary flowchart for BFRR transmission through contention PRACH controlled by a counter in accordance with embodiments of the current invention. At step 901 as the entrance of point (2), contention based RA is triggered for BFRR transmission. At step 902, Counter3 is initialized and set to zero. If a response for a BFRR is received at step 903, the BFRR procedure succeeds and the UE goes to point (4) as the end of the procedure at step 904. Otherwise, the MAC checks whether Counter3 is less than Maximum3 at step 905. If step 905 determines yes, the MAC increments Counter3 by one at step 907 and instructs physical layer to send BFRR on the contention PRACH associated to the candidate beams at step 908. If Counter3 reaches Maximum 3 as determined at step 905, the MAC indicate BFRR failure to RRC at step 906 and goes to point (3) as end of the BFRR procedure. In this case, the RA failure is equivalent to the BFRR failure.

FIG. 9B illustrates an exemplary flowchart for BFRR transmission through contention PRACH controlled by a timer in accordance with embodiments of the current invention. At step 911 as entrance of point (2), contention based RA is triggered for BFRR transmission. At step 912, timer T3 is started. If a response for a BFRR is received at step 913, the UE stops timer T3 at step 914. The BFRF procedure succeeds and UE goes to point (4) as the end of the procedure. Otherwise, the MAC checks whether timer T3 expires at step 915. If step 915 determines no, the MAC instructs physical layer to send BFRR on contention PRACH associated to the candidate beams at step 917. If T3 expires at step 915, the MAC indicates the BFRR failure to RRC at step 916 and goes to point (3) as the end of the BFR procedure. In this case, the RA failure is equivalent to the BFRR failure.

FIG. 10 illustrates an exemplary flowchart for BFRR transmission controlled by one or multiple timers and counter5 in accordance with embodiments of the current invention. It is possible the BFRR procedure requires transmission of PUCCH 1002, non-contention PRACH 1003, contention PRACH 1004 or any combination of above three channels. In one embodiment, there is an overall timer 1005, such as a T4 equivalent to T1, T2, T3 or any combination of the above three timers as one timer to control the procedure of BFRR transmission. In another embodiment, there is an overall counter 1005, such as Counter4 equivalent to Counter1, Counter2, Counter3 or any combination of the above three counter5 as one counter to control the procedure of BFRR transmission. In one embodiment, there are two timers, such as T1 and T5 to control the PUCCH transmission and RA procedure respectively. So T5 is equivalent as T2+T3 as one timer. In one embodiment, there are two counter5, such as counter1 and counter5 to control the PUCCH transmission and RA procedure respectively. So counter5 is equivalent as counter2+counter3 as one timer.

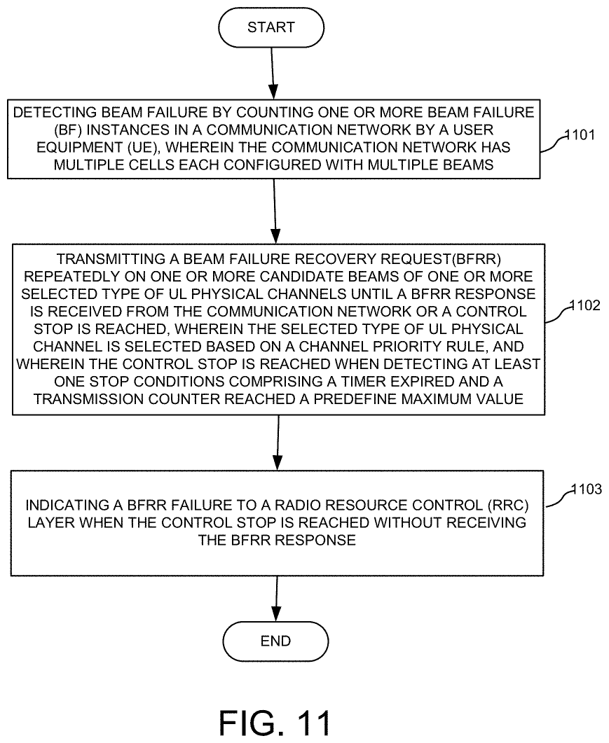

FIG. 11 illustrates an exemplary flowchart for BFRR transmission in accordance with embodiments of the current invention. At step 1101, the UE detects beam failure by counting one or more beam failure (BF) instances in a communication network, wherein the communication network has multiple cells each configured with multiple beams. At step 1102, the UE transmits a BFRR repeatedly on one or more candidate beams of one or more selected type of UL physical channel until a BFRR response is received from the communication network or a control stop is reached, wherein the selected physical channel is selected based on a channel priority rule, and wherein the control stop is reached when detecting at least one stop conditions comprising a timer expired and a transmission counter reached a predefine maximum value. At step 1103, the UE indicates a BFRR failure to a radio resource control (RRC) layer when the control stop is reached without receiving the BFRR response. It is understood by one of ordinary skills in the art that the invention is not limited by NR network, it can be applied to any other suitable communication networks.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
detecting beam failure by counting one or more beam failure (BF) instances in a communication network by a user equipment (UE), wherein the communication network has multiple cells each configured with multiple beams;
transmitting a beam failure recovery request (BFRR) repeatedly on one or more candidate beams of one or more selected type of UL physical channels until a BFRR response is received from the communication network or a control stop is reached, wherein the selected type of UL physical channel is selected based on a channel priority rule, and wherein the control stop is reached when detecting at least one stop conditions comprising a timer expired and a transmission counter reached a predefine maximum value; and
indicating a BFRR failure to a radio resource control (RRC) layer when the control stop is reached without receiving the BFRR response.

2. The method of claim 1, wherein the control stop is reached without receiving the BFRR response further comprising:
selecting a new type of UL physical channel based on the channel priority rule; and
retransmitting the BFRR on one or more candidate beams of the selected new physical channel.

3. The method of claim 1, wherein the one or more beam failure instances are generated by a physical (PHY) layer of the UE and beam failure is detected if numbers of beam failure instances are generated

4. The method of claim 1, wherein the one or more beam failure instances are generated by a MAC layer of the UE and beam failure is detected if numbers of beam failure instances are generated.

5. The method of claim 4, further comprising:
starting a candidate-beam timer when detecting the beam failure; and
stopping the candidate-beam timer when one or more candidate beams are available, otherwise, indicating to the RRC layer of no candidate beam being available upon the candidate-beam timer expiration.

6. The method of claim 1, wherein the channel priority rule is to select a highest priority physical channel that is available based on a physical channel type in a descending order of a physical uplink common channel (PUCCH), a non-contention physical random-access channel (PRACH), and a contention PRACH, and wherein a physical channel is available if there is at least one candidate beam associated with it and no previous control stop was reached on the physical channel.

7. The method of claim 6, wherein each physical channel type is configured with corresponding timer that is started at a beginning of the BFRR transmission on corresponding physical channel, or corresponding transmission counter that is increased by one for each BFRR transmission on corresponding physical channel, or both corresponding timer and transmission counter.

8. The method of claim 1, wherein a BFRR timer, or a BFRR transmission counter, or a BFRR timer and a BFRR transmission counter is configured for BFRR transmissions on all configured available physical channels, and wherein the BFRR timer is started at a beginning of the BFRR transmission and the BFRR transmission counter is increased by one for each BFRR transmission.

9. The method of claim 1, wherein the selected physical channel is the non-contention PRACH, and wherein a non-contention RA procedure is initiated for the transmission of the BFRR.

10. The method of claim 1, wherein the selected physical channel is the contention PRACH, and wherein a contention RA procedure is initiated for the transmission of the BFRR.

11. The method of claim 1, wherein a plurality of candidate beams are available on a physical channel, and wherein a different candidate beam is selected for each retransmission of the BFRR.

12. The method of claim 1, further comprising:
suspending all uplink (UL) transmissions except for the BFRR transmission.

13. A user equipment (UE) comprising:
a transceiver that transmits and receives radio signals in a communication network;
a beam failure indication circuit that detects beam failure by counting one or more beam failure (BF) instances in a communication network, wherein the communication network has multiple cells each configured with multiple beams;
a beam failure recovery request (BFRR) transmitter that transmits a BFRR repeatedly on one or more candidate beams of a selected physical channel until a BFRR ACK is received from the communication network or a control stop is reached, wherein the selected physical channel is selected based on a channel priority rule, and wherein the control stop is reached when detecting at least one stop conditions comprising a timer expired and a transmission counter reached a predefine maximum value; and
a BFRR controlling circuit that indicates a BFRR failure to a radio resource control (RRC) layer when the control stop is reached without receiving the BFRR response.

14. The UE of claim 13, wherein the control stop is reached without receiving the BFRR ACK, and wherein the BFRR control circuit further selects a new physical channel based on the channel priority rule; and the BFRR transmitter retransmits the BFRR using the selected new physical channel.

15. The UE of claim 13, wherein the one or more BF instances are generated by a physical (PHY) layer of the UE.

16. The UE of claim 13, wherein the one or more BF instances are generated by a MAC layer of the UE if a beam failure occurs when one or more candidate beams are available.

17. The UE of claim 16, wherein the beam failure indication circuit further starts a candidate-beam timer when detecting the beam failure and cancels the candidate-beam timer when one or more candidate beams are available, otherwise indicates to the RRC layer of no candidate beam being available upon the candidate-beam timer expiration.

18. The UE of claim 13, wherein the channel priority rule is to select a highest priority physical channel that is available based on a physical channel type in a descending order of a physical uplink common channel (PUCCH), a non-contention physical random-access channel (PRACH), and a contention PRACH, and wherein a physical channel is available if there is at least one candidate beam associated with it and no previous control stop was reached on the physical channel.

19. The UE of claim 18, wherein each physical channel type is configured with corresponding timer that is started at a beginning of the BFRR transmission on corresponding physical channel, or corresponding transmission counter that is increased by one for each BFRR transmission on corresponding physical channel, or both corresponding timer and transmission counter.

20. The UE of claim 13, wherein a BFRR timer, or a BFRR transmission counter, or a BFRR timer and a BFRR transmission counter is configured for BFRR transmissions on all configured available physical channels, and wherein the BFRR timer is started at a beginning of the BFRR transmission and the BFRR transmission counter is increased by one for each BFRR transmission.

21. The UE of claim 13, wherein the BFRR transmitter suspends all uplink (UL) transmissions except for the BFRR transmission.
